(19) United States
(12) Patent Application Publication
(10) Pub. No.: US 2019/0317979 A1
(43) Pub. Date: Oct. 17, 2019

(54) TRIPARTITE POETRY PARADIGM

(71) Applicant: Sang C. Lee, Wayne, NJ (US)

(72) Inventor: Sang C. Lee, Wayne, NJ (US)

(21) Appl. No.: 15/841,373

(22) Filed: Dec. 14, 2017

(51) Int. Cl. G06F 17/21

(52) U.S. Cl. CPC G06F 17/21

(57) ABSTRACT

One of the persistent problems in poetry writing, is difficulty of understanding poems. Poems are relatively brief, and unlike writing essays, or prose, poets had to rely on implying, flavoring, highly symbolic writing. Poems are to sing, and Essay, Prose, is to describe, logically, analytically. Poets cannot rely on writing lengthy prose or essay. Paul Dirac, Nobel Prize-winning Theoretical physicist, said, Poets write simple subjects, as much difficult to understand, while Scientists write difficult subject matters, as simple as possible. The Inventor became aware of the same problems, as he wrote about 1000 poems. Once poet dies, there is no way to ask for clarifications on poems, to the deceased poet. The Inventor's solution to this problem, is to create a Tripartite Writing Paradigm: Part 1. Poem, Part 2. Imagery, Part 3. Fabric of Relativity. Part 2, the Imagery Section expounds the theme of the poem, discussing in detail, relative thoughts, comprehensively. Part 3, Fabric of Relativity, cites Relevant Internet articles, and YouTube.Com videos. The Inventor provides 5 lines for each Stanza, while sonnet has 11 lines, within which, an idea, thought, is organized cohesively. This structure, makes it possible to present the entire poetic writing, well-structured and organized, however complex writing is. Poets and Readers achieve clear understanding of poet's writing.

Humanity has been writing Poems for generations after generations over millenniums. Our hearts call for feelings of humanity, on all different subject matters. Some are lyrical, lighthearted, others are profoundly serious, and philosophical. This urge to write poems, is deeply ingrained in human minds, across the boarder, all ages, sexes, and ethnicity. Some were so serious, and chose writing poems as career. They are called Poets. Though majority of us, simply call them, “Poet”. Actually, there are about two dozen titles for Poet. Some examples are: Verse writer, versifier, rhymester, sonneteer, lyricist, elegist, troubadour, balladeer, idyllist, or Parnassian.

Some degrading title, is Poeticule, meaning a petty or insignificant poet. One noble title is “Laureate”. Shakespeare is famous for writing Sonnets. In the United Kingdom, Poets are so admired and respected, there is a special title, “Poet Laureate of the United Kingdom”. The British Poet Laureate is an honorary position appointed by the monarch of the United Kingdom, on the advice of the Prime Minister. Many illustrious poets were honored with this title, including William Wordsworth, Lord Alfred Tennyson, and Ted Hughes. Poets honored by the Nobel Prize Committee, are called “Nobel Poet Laureate, or simply Nobel Laureate. William Shakespeare wrote 150 sonnets, and narrative poems, with a stanza of 11 lines. Today, many people are into writing Poems. Though majority of people dedicated to writing pomes, are called simply poets. There are many people who are engaged in many different professions with a full-time profession, write poems seriously.

Therefore, understanding poems clearly, has become a serious issue. Generally, people do not openly complain about difficulty of understanding poems. Nonetheless, this is serious, for Poets die, and nobody can ask the deceased poet to help them understand their difficult, but serious poems.

I came across once on the Internet, that Paul Dirac, eminent British Theoretical physicist. Dirac is known for the following comment. Paul Dirac, criticized the physicist J. Robert Oppenheimer's interest in poetry, saying “The aim of science is to make difficult things understandable in a simpler way; the aim of poetry is to state simple things in an incomprehensible way. The two are incompatible. Love poems, Lyrical poems, are generally easy to understand. Some poets write about Philosophical matters, Cosmology, Social issues, thorny subjects and profound thoughts. These poems would be difficult to understand.

I write poems, and call my poems, “Thinking men's poems”. I write poems, almost on a daily basis, my inner thoughts, Essence in life, and Cosmology. I am interested in discovering common threads in thoughts, among different subject matters. Emotions are important to me in writing poems, but also probing rational minds, dominates my poems. I lost my love, who is the most important person in my life, on New Year's Eve, in 2005. I wrote emails to her email address, knowing fully well, she would not be able to read them, and write back to me. It was a way of surviving in life without my love.

In 2008 after 3 years, I no longer could write emails to my late wife, realizing the futility of sending email to a deceased person. I started writing poems in 2008, almost everyday, mainly on my feelings and daily thoughts. Now, I have about 1,000 poems. I started working on publishing poems, on Amazon Kindle. Since I write poems almost daily on my thoughts, I realized. I may be able to apply for U.S. patents on ideas of certain poems. My poems are numbered without title. I had to stop uploading my poems to Amazon Kindle, since U.S. Patent Office, requires Confidentiality until Patent is granted.

I worked last three years, almost everyday, day and night. Now, I have been submitting U.S. patent applications to U.S. PTO online. This application is one of them. International Patents granted, can be applicable globally. My desire is to help humanity. I am living on my pension.

Any income, revenue, generated, including my pension fund, would be put on “Cultural Fund” in my Cultural Trust. These incomes would be strictly spent to promote culture of humanity. Provisions of Trust would not allow any beneficiary to touch the fund. Some benefits for my family, is funded through my pension system. I did not wish to establish a charitable Foundation. Cultural Fund Trust would not accept any gift. That is why I am not establishing Foundation. At my age of an octogenarian, I wish to help humanity, even after my passing. I am working day and night, to finish the work on patents, and Trust structure, to ensure, Cultural Fund Trust. The Trust would pay Taxes, and the Fund would solely dedicated to the mission of Cultural promotion. I personally experienced some difficulty in understanding poems written by others. Anton Chekhov, famed Russian Playwright is also called Father of Short Stories. Some told Chekhov, some people have difficulty to understand his writing. Chekhov replied, Writers are not responsible to please readers. He seemed to have adopted Stream of consciousness. James Joyce, championed Stream of consciousness. His work, Ulysses, 1922, is best known, and the work, is known for adopting “Stream of consciousness”. Many readers may find difficulty in understanding his writing because of this technique.

Poems tend to be cryptic. It is akin to song. It implies, flavors, appeal to emotion. Poems are generally short. Novelists can write thick volumes. But, poems may use phrases to depict a work with multi volumes. Complex events may be depicted in a short stanza. It is not easy task.

Cryptic writings may use technique of alluding, or implying. I suspect, that aspect of poetical writing, may contribute to the difficulty of understanding poems. When a short poem is full of cryptic passages, reader's difficulty of understanding poems will escalate.

For this reason, short titles with a few words, do not do justice. Emily Dickinson, is famous for not giving titles to her poems. Such short title would not properly represent the poem. I, too, do not give titles, but the first line serves as title, primarily to identify.

Some writers may take stand, they write what they want, and in this way of writing, express their thoughts. As Chekhov said, writers cannot try to please a vast number of readers. As artist, a writer must be honest to himself, and keep integrity as a writer. The Inventor, realized, Poetic writings should be accompanied by “Essays”, Prose, illuminating, expounding, and shedding light on the poetry. I call this essay section, “Imagery”, meaning Imagery of the Poem.

### BRIEF SUMMARY OF THE INVENTION

Title of The Invention: Tripartite Poetry

Paradigm Three Parts:

See Detailed Description of the Invention

Part 1. Poem

I provided my poem, “Poem 0806”, as Poetic text example

Part 2. Imagery

Prose Essay, of Poem 0806, Expounding the Essence of Poem

Part 3. Fabric of Poetic Relativity

YouTube.Com Videos, and Internet Writing Resources.

Part 1, is poem (Texts)

Part 2, Imagery, serves to addresses cryptic ambiguity issues. It will help the vast multitudes understand poetry much more succinctly. In Christianity, “Interpreter's Bible” provides commentaries for laymen, even, used by theologians, clergy, scholars, and seminarians. Part 2 serves similar role, addressing this issue. Individual poets and readers may have own interpretations, and that is unavoidable.

Part 3, Fabric of Poetic Relativity, provides Internet Resource, YouTube.Com Videos, Photos, Supportive Documents.

This third, last part, is literature, articles, writings, and most importantly Internet Writings, and YouTube.Com video resources, such as Videos, Photos, On-screen lectures, music, help, Tutorials. It enhances Part 2. Imagery. Such Tripartite Poetry Paradigm, would immensely benefit readers, and poets can discover things, they did not anticipate, while writing poems. This benefits everybody.

### DETAILED DESCRIPTION OF THE INVENTION

Traditional Academic writings, are full of Bibliography, Footnotes, and other citations. Usually, Poetry does not welcome footnotes. The Essence of Poetry, is Emotions. Therefore, Feeling the poetry is important part of Reading poetry. Readers must make their own judgments, right or wrong. Academic circles, looked askance at Internet resources, distanced themselves from the Internet Resources, as support materials, such as Wikipedia, citing poor, low qualities.

Time has changed. Many Resources on the Internet, now, are of high quality. Standard and quality must be judged by academicians, and specialists, on its own merit. Also, voluminous feedbacks by viewers, may touch on technical issues, and quality of writings, and presentations. Writers quoting these resources, screening quality themselves, avoid mundane materials, clarify contents, and tighten up writings.

After all, precious metals, Gold, Platinum, must be mined along with rocks from the deep mine, and refined for use. Digital age requires new vessels. One of my poems attached below, support my views. In my writing, Imagery section is usually much shorter. In this case, I realized, the Essence of Poem, has wide implications in life. So, I selected one poem, that supports my view.

Amazon Kindle, discourages use of Page Breaks, of Printer Era. Few documents on Digital platform, allows Page Breaks. In digital age, it is useless. Xerox is on the brink of expiring. Nobody prints these days. Many go to Staples, once a year to xerox Tax Returns. My HP printer is idle most of the time. I never heard anybody printing emails. You do not mail a hard copy of emails. Send email on-line, copy to many people. When you receive email and you have to forward, reply, you just press keys, to sent on-line. Attachments are used also. There is no need of printing, copying, and mailing anymore. CitiBank, no longer uses Withdrawal, Deposit slips. You provide verbally information to Tellers. Statements come on-line via email. Our Era is in transition, from Hard Copy to Digital. But, transition is hardly finished. Microsoft word is still configured for “Printers” in reading format.

Simple matters like pagination, content tables are no longer fit to the new age. Digital writings are scrolled on the screen. It is impossible to create stable pagination. Scrolling is done in all directions, up, down, right and left. Content table is gone as well. Printers often cannot be used, with traditional pagination, top, left, right, bottom margins for configuring Pages for Printers. Digital, Internet age, is not compatible with printers, in formatting. It still survives, barely limping. Digital publications, discourage “Page Breaks” for these reasons.

Unfortunately, Word software remains a relic of the passing age. No new solutions are available, at this point. In publishing on Amazon Kindle platform, I did not realize these issues until I was trying to upload “Covers” with pictures. Covers do not comply to Configured dimension, based on Printer format, that requires, bottom part of covers get truncated. It is an issue in Hard copy era, but not today's digital age. There are no traditional footnotes, and citations. Nobody does it, and iPhones, iPads, Tablets, are scrolled in all directions on the Bus, Train, stations, everywhere. Without pagination, content tables cannot be made, there are no page numbers assigned, iPad, Digital tablets.

In my writing of poems, I felt, Word software is a relic of the past, unable to reform, redress for today's digital age. Most academic writings, such as dissertations, are still following Hard Copy era. Use of printers, and Xeroxing, have drastically diminished. In digital age, URL address for YouTube videos, immediately retrieve, videos on the browser. I have not heard, any hard copy doing this. Never will. Ultimately, quality of Bibliographic lists and Footnotes, citations, have to be judged by respected scholars or specialists. Wikipedia is constantly revised via contributions of readers. Online publications are generally of high quality, though it depends on the person who selects. Various academic societies are using them for publications, and academic discussions at forums. Banks are pressuring customers to switch to on-line transactions. Even statements are primarily issued on-line. I used to get cancelled checks each month from my banks, but no more. You never see cancelled checks, only photo image is printed on the back of statements. Many banks, never use hard copy slips for deposit and withdrawing cashes anymore. You have to tell Cashiers, verbally with no hard copy slips, Customers are required to present Driver's License for ID, when verbally doing transactions at Cashier's window.

One important aspect of these materials, is, they are digital, accessible via Internet Browsers. Efficiency, productivity, accessibility, are phenomenal, highly accessible to all, and productive. Wikipedia articles are very high in academic quality. Many deals with highly technical subjects.

Some of us who went through stacks of books in the library, manually reading, writing down, and citing the sources, know how inefficient, time-consuming, and onerous the task is.

This Tripartite Poetry Paradigm, helps average people, even poets, and specialists of various subjects, to comprehend the Poem. Ambiguity, and ambivalence, are removed. More poets would share their true feelings with readers. This way, poets can write poems with full confidence, readers would understand, and appreciate his poems fully. In poetic writing, emotion plays a huge role. Frequently, a line or two in a poem, surmise volumes of Books in prose, or historical events. This necessity, is partly behind ambiguity, ambivalence. A poet may describe a volume of book in a couple of sentences or lines. That is a nearly impossible task. It is a necessity, a poet cannot avoid, the differences between poem and prose. They are substantial. Poets cannot worry too much about ambiguity and symbolic nature of his poems. Often, he is the only one who understands his poetic writing. Sometimes, poets themselves may not comprehend.

Words gush out from Poet's minds and hearts. I suspect, there are occasions when poets themselves, really do not understand, but, somehow compelled to use particular expressions. It is in a universe, math and physics cannot fully explain, but poets are convinced with the expressions he writes.

A huge wooden boat was found in the middle of desert. People scratched heads, trying to come up with reasons, on how the boat navigated over the desert. The desert was once covered with water, part of the sea. That is how. Geology changes. Continents change. New Jersey, cliff near the Washington bridge was once part of Supercontinent Pangea, thousands miles away. Tectonic drift, split Pangea, breaking apart to form Americas. There is evidence, continents may drift back to form supercontinents again.

Change seems to be part of Tectonic drift. Apparently, nature had to adapt, including all creatures. When changes come relatively in short span, Humanity must adapt to survive. It is the built-in Pulse of Nature. We should remember. Technological changes are becoming faster. We have to go with the flow of changing times. I am presenting one of my poems as an example of Tripartite paradigm format. This will illustrate many points I raised above. Incidentally I never assign a title to my poem, fearing it will prejudice readers in a wrong way. A few words cannot explain the whole concept and thoughts of poems. In my case, the first line of my poem, is used as title. But, this serves purely for identifying poems. Emily Dickinson never gave titles to her poems. I suppose, she had the same feelings, I have described above.

Inventor's Work, below, serves as actual example, as part of DETAILED DESCRIPTION OF THE INVENTION (1. Poem 0806, 2. Imagery, 3. Fabric of Poetic Relativity)

Poem 0806 (Part 1)

New Vessels for New Thoughts (Title)

Sang Lee

Nov. 14, 2014, Friday

New vessels for new thoughts

New vessels for new ideas

All new thoughts, ideas, become

“Has been” or old hats

Humanity prowls ahead, new habits, habitats

Entropy, “Getting used to”

Eventually lead to “Comfort”, “Complacency”

Vigilance is called for, to be freshened

Air becomes stagnant without being refreshed

Else, humanity becomes naked

Insipid, dreary, ho-hum, humdrum

Tiresome, lifeless, wearisome

That lead to dullsville, irksome

Stale, sterile, bleak, death follows

Life calls for being reborn

Fresh new start

That changes the game

New rules, mores, put on new clothes

On dreary life of humanity

That is why we celebrate pendulums

New Year, birthdays, anniversaries, holidays

All those annual swing, refreshing

For a day, we slip into new clothes

Body replaces spent cells

Virtual reality starts anew in our brains

Spanish coined apt expression

“Manyana”, not today, tomorrow maybe

Newton called it “Inertia”

All things love to stay as it is

Gravity takes hostage of life

Life needs to put brake, pause

Reflect, and recharge battery

Raise head, eye at the edge of the Cosmos

Big thoughts, smart ideas may wink at you

Rise up, grab them, and Go!

And, be blessed, with a new start, resolution

Knowing fully well

Recycle, will change to Renewal

Heart will stir, pump fresh blood

Stars, nabulae, supernovae, jolt, flash Gamma Rays

Poem 0806 (Part 2, Prose Essay)

New Vessels for New Thoughts

Sang Lee

Imagery

Chinese language, writing, consist of a string of characters, each character being an abstract symbol.

Generally, lacks embellishment. I shun frequent use of “And”, “A”, “An”. I think, it only makes writing murky. I like “to-the-punch” approach. There are also about 160 languages lacking Definite or Indefinite articles. Korean, Japanese, Chinese languages are examples. I also frequently ignore grammar Poetry needs freedom in expressions. That is what I believe. Stream of Consciousness, James Joyce championed, in reality, goes back long. The term was introduced by William James, funny, name, “James”, is shared by both men, one is last name, and the other first name. Anton Chekhov, also shared the view, adopted it in his writing. Someone pointed out to Chekhov, readers are baffled with this aspect of his writing. He responded, writers are not responsible to make readers happy.

It is my view, that Chinese people had this notion from ancient times. Chinese language and characters are unique in the world. Each character codes thoughts and notions. If you think carefully, this is an astonishing approach. Thoughts and ideas are boiled down or condensed into a character. More characters are added in composite, in double or triple-decker, to express more elaborate expressions. This device is often used to create new words. That is the reason why there are so many Chinese characters. In alphabetical world, barely 24 or more characters are used to phonetically render languages. English language embodies this approach. There are European languages adopted the same. Korean and Japanese languages, being geographically very close, have alphabets. Korean alphabets are famous for scientific, and logical construction of purely phonetic alphabet. There are no silent characters and each phonetic alphabet character is pronounced exactly the same, as written. English language as sophisticated as is, the same alphabetic character is pronounced in many different ways. This complexity makes the language very difficult to learn for foreigners. I am afraid, native English speakers have also difficulties. A word may have pages after pages of different uses, in English Dictionary.

China with vast population and almost continent-like country, K-drama industry pays attention. Many K-drama has Chinese and Korean language options, and subtitles. Although I do not speak Chinese, I learned considerable number of Chinese characters in my youth. Often, I am astonished, there are vast different approach in creating words and phrases in Chinese language, writing. We say “Cheers”, “Cheer up” to stimulate energy flow anew. Chinese uses two characters. First character stands for “Add” and the second character, “Oil”. In other words, “Add oil” stands for “cheers” or “cheer up”. Probably, underlying notion is “to add energy”. This different thinking or approach can be attributed to the unique nature of Chinese characters. In alphabetical world, predominantly, we create new expressions. In Chinese language, they are a hostage of symbolic characters. Often, they do not create a new unique expression. They use existing characters in composite, to create new concepts and expressions. Hence, “Add Oil” for simple, “Cheers!”. This is insane, characters become extremely complex. Humanity losing short memories, and deteriorating in memory as age creeps in, this takes tremendous toll.

Chinese characters number 80,000 or more, and no end is near in sight. It is beyond critical limits of human memory. Pinyin, Romanization device for Chinese language, a Modern Invention, is at best, a stopgap measure. It needs new courage, fundamental turnaround.

Chinese leaders tried new approach, Limiting characters to 500, or 3,000. It does not resolve problems. It only makes vast Chinese population illiterate. Nuclear armament, is not the answer. Expression, “Rub Salt to Wounds” comes to mind. Full-Blown switch to Phonetic Alphabet, taking decisive switching, is the answer, China Needs New Vessel, new radical thoughts.

Despite this difficulty, Chinese language has a unique advantage. Symbolic characters compresses thoughts, ideas into compressed characters. It is a sort of converting “Meaning” to a Landscape. It helps to comprehend meaning quickly. It means, content of a page of document, is vastly reduced in length, needing much less real estate. This is the advantage of symbolic characters. Of cause, an entirely new character may have to be invented, ground-up, constantly. On the other hand, writing, learning Chinese characters exact enormous prices in terms of memory and time. Chinese tried to reduce the number of characters unsuccessfully.

To understand Symbolic Language, one needs Stream of Consciousness, to leap in imagination.

The vessel of language, characters and alphabet, has much impact on language development. I feel, conjugations in Japanese and Korean languages provide refinement, delicate dimensions, and sophistication, shading imagination. It provides rich nuances, precisions, in expression. They bring Degree of respect, delicate interpersonal touches, precision in time, tense, and some other benefits. “Conjugation” of verbs brings advantages to Japanese as well as Korean languages. Korean languages are much more so than Japanese. There is a sense of abruptness in Chinese language. Chinese language is a string of coded characters, rarely have punctuations, commas, for instance. Period is nonexistent. They do not feel the need for them. “Space” will do. No page break is necessary. Incidentally, page break is literally gone in digital age.

The age of Internet adopted, endless flow of thoughts. Here, Symbolism intercedes Stream of Consciousness. Both avoid pure descriptive approach. It is Metaphor, and Virtual thoughts.

Chinese language and writings with symbolic characters, remind me of the Bletchley Park code breakers. They would love the device. They would love the Chinese characters and writing, though it may give them gigantic headaches. Chinese writing is almost like a long string of symbolic characters, Spaghetti noodle, a la mode coded messages. It is never-ending strings of Spaghetti.

It is very economical. I experimented in free format and different ways of writing poetry.

Since my poetry deals with thoughts and ideas primarily, it gets very complex in content. I felt, I needed a concise, rigorous format, to organize, and present my thoughts. I settled to a regular stanza, that has 5 lines. Six or more are too long, and less than 5, is inadequate, too fragmentary. Universal default format is to use font size 12. That has enough packing power in verbose age of the Internet. But, it strains eyes to read March of tiny ants, especially working at computer, watching screens, for ten hours or more a day. With reluctance, I scaled up to Font size 14. It is still too small. But, that is the best compromise I could make. Larger font sizes require larger real estates, screen, windows, in Internet, digital, computer age.

Even changing font size, from size 12 to 14, required enormous amount of rewriting of nearly 1,000 poems. I barely did 200 of them so far, though, now, I found more efficient ways.

Digital age has no love for “Printer oriented” format. Printing is handled by Operating software. Page numbers, Page Breaks, Margins for top, bottom, and two sides, left and right. Watch in subway train, people scrolling in lightening speed, swiping up, down, top, below.

Fashionably dressed young women and men, crisply clad college students, feverishly scroll screens swiping with fingers. Even old age people. Lo and behold, aged, and young, unsophisticated country fellows, and urban people, are busily doing the same thing. I do not use iPhone, never needed. Watching the frenzy of finger-swiping, I feel, I am old, and outdated. My time is gone, over. Printers, word software, are far behind time. No index, content tables are necessary. Margins chew off characters up and down. Or, downright refuse to print.

Human beings, biological, cannot avoid consideration of “Receptacle”, “Vessel”, or “Container”. We are used to have two sizes of papers for writing, Letter size (11″ length), Legal size (14 length). Both, have the same width of 8.5 inches for printers. Landscape format, has 11″×8.5″. U.S. PTO, does not accept Landscape format. An evolutionary development necessitated by typewriters and printers. In digital age of Internet, email, digital age, this is becoming archaic. People hardly print any these days. Business and corporations are pushing people hard, to give up hard copy format, and move onto digital format. Our vision, eyes also require them. In digital age, the length became immaterial. “Flowing text” is alien to a fixed length of document, that is a vestige of Hard copy, Printer format age.

Documents are rarely faxed, email attachments took over, even though it is rarely used.

iPhones and Tablets, are now main stream equipment. Needless to say, computers, laptops, are almost becoming obsolete.

Since digital writings do not need storage, filing of paper forms, formats, word software have to be changed. Even the use of mouse devices, are no longer in fashion. Finger tips took over. People, generally touches, swipes with finger tips, for scrolling.

Word software, carries the vestiges and history of Printing. Microsoft Word software survived while many other software perished. Microsoft's Word relied entirely on Printer formats, that is provided by manufacturers. Margins, page length, fonts, are all inevitably closely related to Printers. In turn, Computer Operating System controls them. Repagination is unheard of. It has conflict with digital age writing. It is my view, this has to change. For example, a graphic rendition, particularly in color, has problems with Word format, converting, reformatting. Word format documents have problems in converting, when color drawings get involved. Pagination is no longer needed. Margins, paginations, headers, and footers, are relics, even indexing, contents table provision. It affects traditional content tables, in which page numbers are fixed, against the concept of “flowing text” format of the digital age. Indexing is also antiquated.

Imagine, an iPhone user has to go by page number for locating a spot in texts. Texts are, as in Chinese language and writing, flows forward, even sideways, and up and down. Content table based on fixed page numbers, is no longer possible. Now, Mouse pointers became irrelevant, fingers jump, scroll, and swipe. The way finger tips are flying, is fantastic.

Fingers are challenging jets in speed or even speed of light. Practically, all citizens mastered them. The minute people arrive waiting rooms, ride a train or bus, lining up ticket windows, everybody swipes iPhone. This keeps brain busy, at all time. English language is strictly ruled by “Grammar”. There are elaborate rules in writing. I find it very difficult to fit an idea, thought, into 8.5 inch width.

I felt, “Stream of Consciousness” writing technique is called for. Many times, I am forced to skip conjunctions, grammatical syntaxes, following Chinese language writing. “The”, “A”, “An”, definite article and indefinite articles, pack writings, they are burdensome, ubiquitous, obsequious. You spend eyeballs and your mind, reading conjunctions and definite, and indefinite articles. Conjunction “And”, “But” and others clutter writing. It becomes like mechanical, verbose, and redundant. In fact, there are about 160 languages that do not have them. “This” and “That”, one or two, would do, if precision is necessary.

Occasionally, in idiomatic usage of “the”, “a”, and “an” insist on me to use them. I usually comply to requests.

I think, English writing should allow flexibility in these areas, making it succinct, direct, and concise. I would be reluctant to get help from “Editors” in my poetry writing, because they would not understand my feelings on grammar. They would obliterate my writing without realizing my views on them or purpose.

Superfluous words impede flow of thoughts and reading. They hang around, like lace flopping and hanging around in bygone eras of Elizabethan and Victorian era. We do not need dazzling tiny light bulbs of a Christmas tree.

New direction in writing is not limited to formats. Flowing texts, require entirely different approaches than paper sizes, margins, fonts. Zoom in, Zoom out, and Actual size, overtook. The way words are presented in terms of orders, contexts, require new thoughts.

Bright ideas, thoughts, tend to be looked at not seriously. As it gathers momentum, and receive significant attention, it may change. There would be new ways of stringing, ordering, presenting words. New discovery and technology, may soon emerge. The prevailing, past views become spurious, and out of date. A new truth, and revolutionary theories and views may emerge. Stream of consciousness, and symbolism, would become dominant. Even Chekhov was into it. Newton observed an apple falling off tree. He came out with a theory of gravity, motion theory, inertia. Celestial bodies, stars, planets, obeyed Newton's theory of gravity. They became universally accepted. Newton believed in Static Universe.

Einstein rode on a bus, observed tower, fading in the back and clock receding smaller in Doppler effect. Einstein noticed, a moving body, the faster it moves, time slows down. Einstein realized, gravity worked through Space-Time fabric. His Relativity theory was proven correct. Observation of Solar Eclipse proved it. Newton's Static Universe became dethroned. Gravity theory underwent revolutionary changes. Without it, GPS system would not exist.

Even, Remote controllers would not exist. Then, Bohr, came out with Quantum mechanics. Quantum gravity, in world of sub particles, could not be reconciled with Einstein's gravity theory of large celestial bodies. M-theory of string theorists, claims, underneath atomic sub particles, as Quarks, there are tiny strings vibrating. They claimed, that resolved conflicting gravity theory of Quantum gravity for small particles, and Einstein's gravity theory for large objects, celestial objects, and the world of sub particles. I do not believe in, harrowed Standard Model and String theorists' views yet, their claims notwithstanding.

The above discourse on language, format, are all in support of necessary “Changes”, needs for new vessels. It is direly, urgently needed, but, publishing industry, even Microsoft, computer, digital technology leaders are trailing way behind. Word software, is forever bonded with printers. Printers need drastic changes as well. Xerox, and Hewlett Packard, are in doldrums, with sleepy eyes. Mega Book stores such as Barns and Noble, are on the wane.

Industry screams for “New vessels”.

Jeff Bezos of Amazon.com, started new business model, of Amazon.com. Business did not pay much attention, Stock prize hovered below $50, then, a revolution took place. Now, stock price swings around $800 or higher. Amazon.com pushed On-Line retailing, without stores and real estates. Now, it is shaking the world of retail business. Venerable Macy's is drastically reducing number of stores. Sears, J. C. Penny, Walmart, and others are following the lead of Amazon.Com. Walmart is changing the course, buying On-line Retail company.

Amazon is venturing into Space travel business. Walmart business, depends on imports from China Trump, is pressuring China, slapping tariff and Walmart is facing daunting change of business model.

Nothing can survive without change, adaptation of new business paradigm. Theories keep evolving. New Cosmic theories supersede the old theory. “New Vessels” were needed for new theories and discoveries. Higgs Boson finally won Nobel Prize for Peter Higgs.

Nobody can be sure, the current theories prove to be the final. Physicists are first to admit this. Digital technologies seem to revolutionize electronic and digital technology.

We all know, our brains do not work the way digital technology does. Computers have been working on the basis of Binary digital technology, ones and zeros. IBM claimed, it has Quantum processors, and lately other scientists claim, they found the way to make computers work like our brains, not in old Binary mode. Quantum technology is itching to debut, if not already, to change computers. Microsoft, to their credit, announced, they have invented “HoloLens”. It displays holographic, 3D images in the air.

In ancient times, clay tablets, and sheep skins were used as recording medium. Then, paper was invented. Next, digital screens are used in computers and digital tablets. It is displayed in air, 3D holographs.

Printing industry is on the wane, as Xerox. Hard copy bookstores have been downsizing and disappearing. Newspapers are not too behind. Readership has been dwindling for some years. New York Times Delivery had to deliver eggs and groceries in addition, to supplement income.

Each revolutionary invention and discovery call for new media, and infrastructures. These latest technologies are relatively in infancy. But, it is for sure, new “Vessels” are needed for practical uses of the masses.

Google's Chief Executive, Erich Schmidt, just declared, Internet age is over. Actually, what he meant, was technology would evolve drastically different from what we have at this time. Academic tests, engineering, scientific exams are testing human memories. Google glasses and Microsoft's HoloLens make it obsolete. iPhones and iPads are constantly updated. New versions and operating system software, are flooding markets. Poor consumers have to dish out dizzying array of “Money” to buy new versions. Cell phones used to be small, now, they are like a note pad in size, and surprisingly heavy.

That is the theme of this poem. Progress make current technology upside down. Drastic new technological, scientific progress, makes current, most advanced technology obsolete, calling for new mindsets, or “New Vessel”.

But, it is not limited to hardware devices.

New thoughts require new “Minds”, new attitudes, and new, creative, imaginative thinking.

We are so often prisoners of “Old” thinking, we have hard time to accept “New” age. New thoughts require changes in our attitudes, habits, mores, and interpersonal relationships. Dynastic “Kid” of North Korea, is just archaic. World, people are suffering. Yet, mighty technology, arms, are having difficulty to change feudal dynasty of North Korea.

We have witnessed, dictators, totalitarianisms collapsing. Discredit communism, Bolshevism, Che Guevara and Fidel Castro's everlasting, permanent revolutionism, came and gone.

Hitler's Super Aryan cultic belief, killed over 60 million people. Some say, 80 million lives or more. East Germany's famous Berlin Walls, came down overnight, as soon as Reagan demanded. Stalin's brutal terror, is gone forever with his death. Soviet Union collapsed. How many people suffered from Communism, is beyond imagination. Empires based on power of a few people, nation, saw collapses. Japan's militaristic expansion came down like sand walls on the beach, washed away by incoming little waves. Now, radical religious belief, is committing the same mistakes. Poor humanity still suffers from narrow, intolerant group of people.

Sanctity of “Life” is sacrosanct in all religions, and atheists groups. It is inconceivable, a lone bomber detonates bombs on the belt around his stomach, and wreak havoc, with the belief, having 80 virgins for himself. Rampant consumerism, produce products at any costs, sell and sell new stuff, is destroying our planets, and the future of our children. Segregation, discrimination, based on skin colors are still with us. Lowly animals like dogs, seem never bothered by it. Then, why ennobled humanity, clings on to this old thinking, attitudes, vessels outdated, old mores?

All humans came from two individuals in East Africa, a man and a woman, not necessarily a married couple. Genes attest. In the age of global travel, migration, and population movements, interracial marriages, are ever increasing. Korea used to be nearly of one pure race, until 100 years ago. Geographical isolation and rugged mountainous country brought this isolation for millenniums. A half century ago, in Korea, no other country people were seen, let alone mixing blood, lineage, in society. International marriage was looked at askance. No foreigners spoke Korean. I am astonished. Now, young women all over the world are coming to Korea, in the Internet age, and intermarry with Korean youth, though primarily Korean men and foreign women, at the moment. This was necessitated by overwhelming Korean population living in cities. Seoul metropolitan areas have 40% of Korean people, over 70 or 80 million people living. In rural areas, there is a dearth of young women population. So, people are forced to marry women, several thousands mile away, across oceans and many continents. All different skin colors, white, yellow, and black.

Mostly, families of mixed color, live in harmony. A miracle.

Fortunately, international marriage of young people, seem to be working well. Families are accepting them as well. It is one of the most astonishing changes in Korean people, and Korea's history. Korea has 80 million people, North and South, and worldwide, mostly living in Korea's narrow peninsula. It is very encouraging. Korean genes are getting diversified every day. They say, about 15% of population in South Korea, come from international mixed marriage. Seven billions of people in the world, are biologically, reproductively, completely compatible. Otherwise, humanity does not have chance to survive on Earth.

It is heartwarming to see families of Korea and foreign countries, are genuinely embracing newly intermarried couples, children, and families. They are called “Ta Mun Wha” people. It means, Multicultural people.

We have myopic views and zero tolerance in tiny areas. What is important, is the realization and discovery of larger principles that seem to exist in many areas and things, in common. We have to discover the fundamental truth that seems to be working in various phenomena.

Sooner or later, aliens may visit the Earth. To them, humans may be like insects, when their civilizations are much more advanced. Hawking seems to think that way. He gives 100 years before Humanity moves out to Exoplanets, light years away. Some even think, humans and machines are destined to coexist in our bodies. Rogue asteroids, comets, celestial bodies, may decimate the Earth, wiping out all life. Super volcanoes may destroy us at any time. We have no defense against these apocalyptic, or cataclysmic events and forces. Humanity may have to travel space, risking genetic changes from radiations.

These catastrophic events seem to visit the Planet Earth, periodically. We have to stop killing each other. We have a very short time before moving out to Exoplanets. No less person than Stephen Hawking, insists. He thinks, we have to move away from the Earth, within 100 years.

There is no time to vacillate, to be dilly-dally, shilly-shally. There is unspeakable Urgency in the air. Sixty five million years ago, a huge asteroid, 6 mile-wide, hit Yucatan Peninsula.

Wiped out all dinosaurs and 70 percent of creatures of the Earth. Tiny mammals, micelle, emerged from underground hideouts, and developed the age of mammals. We descended from them. Science tells us.

So, changing vessels, from outdated old mold to new forward-looking one, is absolutely needed. There is no time to dither. Our planet is being destroyed by human civilization and technology. Climate is changing. Sea levels are rising ready to swallow coastal areas, and islands. New York City may become “New” Venice, albeit momentarily, before sinking to sea bottom. As it is, seven billions of people are doing enough damages. But, population is increasing ever more. Trouble is most humans would be either too old, over 60, or too young, below 10, to sustain human population. Demographers are warning. China, Russia, Japan, huge countries are facing disappearance from the Earth. America, being the nation of immigrants, is an exception. Korea has 1.2 annual population increase per person. Unprecedented influx of young women from all corners of the world is helping. As of now, they constitute 15%. The miracle of pure ethnicity, is reversing its course luckily. The oceans are full of human junks, in giant gyre. Vast oceans are no longer capable of swallowing plastic junks, we toss casually to the sea. Antarctic Continent is melting alarmingly fast. All those ice continents melting, Sea water would lose salinity. Stop squabbling. Time is running out. Get out of the shadows of fossil energy. Cleanse air and water. Slight changes and events, may deprive drinking water from billions of people. No technology can immediately address the problem. It is time to kick off inertia. We must change or else, we are doomed. Every large and little countries, want to possess nuclear weapons. North Korea's young despot, threatens to start atomic war against South Korea, and the U.S. China, a lone, long time allies of North Korea, seems to realize the dangerous implications of North Korean threats. They may make small, portable atomic weapons, that a radical young man or woman, may use to destroy civilization of nations and people. So far, no politicians have any idea how to bring the nuclear destruction under control over the rogue, vigilante North Korea.

ECB, European Central Bank, is working on easing monetary flow, lowering interest rates, U. S. Federal Reserve Bank, is about to go the other way around, raising interest rates, making lending of money more difficult, and raising interest rates. The world needs a central institution looking the world as one system. We cannot afford to divide the world and administer conflicting policies and tactics.

Now, we have regional conflicts in Radical Moslem movements, of ISIS, and anti-terror armed struggles of democratic countries. What is important is for changing religious leaders of anti humanistic views and actions. If a group of people, armed to teeth, firmly believe in going to paradise and heaven, after death, by committing hideous acts of beheading and taking lives away, there is no better solution than changing such beliefs. Only, religious leaders can address this, and bring changes by fundamental change of radical views. Mindset must be changed.

Collateral harms on civilians and innocent people, are profound issues. Unchecked, this will topple humanity over.

United Nations, regional institutions, and Governments must undergo reform. Humanity must rally around the same humanistic views and beliefs. Otherwise, solutions would never be found.

Brexit, the exiting of Britains from European Union, is sad. It is reversing the course, walking away from EU. Trump insists on nationalistic view. He may have profoundly different views from most of us. Hope, he is right.

Establishing a common language, in addition to various mother tongues of people, country, regions, and ethnic groups, would provide a common platform for dominant culture, civilization, technology, and it is of primary importance. Seven billions of people must feel, think, and live as one species, though ethnic cultures have to be protected and encouraged. English language provides a central rallying point and platform for humanity. It will ease the pain of radicalism, encourage communication, and help establish pluralistic societies and culture.

EU, European Union, came a long way. Despite occasional squabbles and Brexit, regional association, around which nations work together, is absolutely necessary. Regional alliance, such as EU is not working. Germany is supplying goods to All EU countries. EU countries cannot serve as EU market, lacking economic wealth to buy from Germany, Although there are many regional unions formed, they are not integrated as states in the U.S do.

Unions for South America, North America, Africa, Asia, Southeastern regions, Pacific regions, must proceed promptly. Asian countries, China, Korea, Japan, India, Indonesia, Myanmar, Australia, must be formed, and tightly unite political, financial, economic, foreign relations, into a functional system. This has advantage of resolving all vital issues among member countries of regional unions. Member countries must be economically viable.

Then, United Nations would have firmer basis to resolve world conflicts and problems. To negotiate with each member countries of the world, at United Nations, is not workable. The United States is a prime example. Even, Soviet Russia, got dissolved into Russian Federation. In the process, many countries seceded, like Georgia and Ukraine. Regional cooperations can be easier, to resolve conflicts of nations. Now, all citizens and countries must share equal stakes, wealth, and technology.

Time is gone, when advanced countries become rich and exploit smaller, poor countries and cheap labor. World economic systems must attain equilibrium. People must share decent living for all individuals, societies, and countries. Taking advantage of cheap wages of poor countries, is gone. Economy has to provide equal purchasing power, and standard of living, throughout the globe. When you don't have money, purchasing power, it gravitates to old Colonialism. World trade and market, cannot coexist with poor nations. Stake must be raised.

There are billions of people, servicing on 2 to 3 Dollars a day. Billions of people subsist with 3 dollars a day. People die on streets, sick, old, poor, and hapless. Talk is cheap. Now is the time for brotherly love, equilibrium, equality, and sharing wealth, technology. Nations and people need money, purchasing power, in order to have functioning world economy. No matter how you slice and cut the cost of labor, eventually advanced countries would run out of markets to sell goods. Planned economy of communism failed.

They tried to micromanage economy. But, the world must cooperate and coordinate economic and financial systems, in democratic societies. People must have free enterprise. The cost of retaining large military units, weapons, are becoming everybody's burden. If there is less crime, there is no need of maintaining large police force or prisons. Border problems are there, because poor countries and people cannot make living in their backyards.

Ultimately, Border walls are not final solutions. Best solution for crimes, is make world population reasonably rich, equalize wealth. Only then, Equality Comes. Regional prosperity, stability, is the permanent solution. Share technology, resources, and wealth with world. When clean water is abundantly available to all people, there is no need of fighting for drinking water.

That is the new Vessel needed for peace, prosperity, and survival of human species All things are said and done, Humanity as individual, must become wise, and enlightened. That is the underlying power for “Change” and “Reform”. Seven billions of life, must serve for the course of Humanity. After all, ants and bees seem to have done without long deliberations, nor squabbles. All of us, need “New Vessels” for New Age.

Poem 0806 (Part 3, YouTube.com, Internet Literature)

New Vessels for New Thoughts

Sang Lee

Fabric of Poetic Relativity

Paradigm shift

(Copy, Paste in Internet Search Box. Select title and hit Return)

Creative thinking

(Copy, Paste in Internet Search Box. Select title and hit Return)

Neutrinos, Einstein, Time and Paradox

(Copy, Paste in Internet Search Box. Select title and hit Return)

Dark Matter

(Copy, Paste in Internet Search Box. Select title and hit Return)

1. Readers' complaints about Cryptic writings of poets, are addressed by adding Prose Section in Tripartite Poetry Paradigm, of Poetic writing: Part 1. Poem, Part 2. Imagery, Prose, Part 3. Fabric of Poetic Relativity, Relevant literature from Internet, and Videos from YouTube.Com.

2. While Sonnet, has a stanza consisting of 11 lines, the Inventor provides, a Stanza of 5 lines, enabling poet to present an idea, thought, well organized, and succinct.
